(19) United States
(12) Patent Application Publication
(10) Pub. No.: US 2014/0359585 A1
(43) Pub. Date: Dec. 4, 2014

(54) METHOD AND DEVICE FOR COMPILING A SOURCE PROGRAM

(71) Applicant: THOMSON LICENSING, Issy de Moulineaux (FR)

(72) Inventors: Jean-Eudes Marvie, Betton (FR); Cyprien Buron, Rennes (FR); Patrice Hirtzlin, Betton (FR); Pascal Gautron, Rennes (FR)

(21) Appl. No.: 14/372,009

(22) PCT Filed: Dec. 19, 2012
(86) PCT No.: PCT/EP2012/076236

§ 371 Date: Jul. 12, 2014

(30) Foreign Application Priority Data
Jan. 12, 2012 (EP) 12305042.9
Jan. 12, 2012 (EP) 12305043.7
Dec. 19, 2012 (WO) PCTEP2012/076236

(51) Int. Cl. G06F 9/45; G06F 17/30

(52) U.S. Cl. CPC G06F 8/41; G06F 17/30958
USPC 717/139

(57) ABSTRACT

To compile a source program comprising first rule(s) not supported by a target environment and to enable the first rule(s) to be executed on the target environment, the method comprises generating a directed graph representative of the source program, generating a first data structure corresponding to a flat representation of the directed graph, first data structure comprising at least a first identifier associated with the at least a first rule, and generating a second data structure comprising first instructions adapted for interpreting the first data structure by using the at least a first identifier, the instructions being coded into a code supported by the target environment.

### 1. DOMAIN OF THE INVENTION

The invention relates to the domain of interpretation of rules by a graphics processing unit, especially the interpretation of procedural rules for the composition of synthesis images. The invention is also understood in the context of special effects for a live composition.

### 2. PRIOR ART

According to the state of the art, GPU (Graphics Processing Unit) programming only supports a classical compilation scheme, in which the source code is directly compiled into native executable code. However, GPU programming languages, such as GLSL or HLSL, only support a subset of higher level languages. For example, recursive algorithms cannot be implemented using the programming languages used for GPUs. According to the prior art, it is known that if a function is repeated N times (N≧2) in a program with a given set of program parameters, the body of the recursive function will be repeated N times to provide an equivalent behavior. While this provides a solution when the input parameters are known beforehand, this becomes very difficult to manage when the input parameters can take any value. In this case a separate program would have to be generated for each new set of parameters, which is extremely complicated if the number of parameters sets is high. Moreover, a new compilation step is also required when modifying the number of recursions at runtime leading to poor runtime performance.

### 3. SUMMARY OF THE INVENTION

The purpose of the invention is to overcome at least one of these disadvantages of the prior art.

More specifically, the purpose of the invention is to enable the execution of rules not supported by a target environment on this target environment.

The invention relates to a method for compiling a source program, the source program comprising at least a first rule not supported by a target environment. As to enable the executing of the at least a first rule on the target environment, the method comprises the following steps:
generating a directed graph representative of the source program,
generating a first data structure, the first data structure corresponding to a flat representation of the directed graph, the first data structure comprising at least a first identifier associated with the at least a first rule,
generating a second data structure comprising first instructions adapted for interpreting the first data structure by using the at least a first identifier, the instructions being coded into a code supported by the target environment.

Advantageously, at least a rule type, at least a successor and at least a rule expression are associated with the at least a first rule.

According to a particular characteristic, at least one of the at least a rule expression is a parametric expression, the at least a parametric expression comprising at least a global parameter modified at runtime.

According to a specific characteristic, the at least a first identifier identifies the at least a rule type and wherein at least a second identifier is used in the first data structure for identifying the at least a successor and the at least a rule expression.

Advantageously, the at least a second identifier identifying the at least a successor identifies a pointer pointing to a second rule identified in the first data structure.

According to a particular characteristic, at least a local parameter is associated with the at least a successor, the value of the parameter being modified each time the at least successor with each the parameter is associated is pointed in a first rule.

According to a specific characteristic, the at least a first identifier and the at least a second identifier belong to at least a series of integer according to the type of the values taken by at least a rule type, the at least a successor and the at least a rule expression, the type of the values belonging to the group comprising:
an integer,
a float,
a Boolean.

Advantageously, the method further comprises a step of generating a third data structure comprising second instructions adapted for interpreting the at least a rule expression, the second instructions being coded into a code supported by the target environment.

According to a particular characteristic, the method further comprises a step of generating a fourth data structure comprising at least a global parameter comprised in the source program.

According to a specific characteristic, the method is implemented on a source environment that is different from the target environment.

Advantageously, the source environment implements at least a central processing unit and the target environment implements at least a graphics processing unit.

The invention is also directed to a device configured for compiling a source program, the source program comprising a first rule not supported by a target environment, wherein the device comprises at least a processor configured for:
generating a directed graph representative of the source program,
generating a first data structure, the first data structure corresponding to a flat representation of the directed graph, the first data structure comprising at least a first identifier associated with the at least a first rule,
generating at least a second data structure comprising first instructions adapted for interpreting the first data structure by using the at least a first identifier, the first instructions being coded into a code supported by the target environment.

Advantageously, the at least a processor is a Central Processing Unit.

The invention is also related to a computer program product that comprises instructions of program code for executing the steps of the compiling method, when the program is executed on a computer.

### 4. LIST OF FIGURES

The invention will be better understood, and other specific features and advantages will emerge upon reading the following description, the description making reference to the annexed drawings wherein:

FIG. 1 diagrammatically illustrates a source program under the form of a decorated parse tree, according to a particular embodiment of the invention,

FIG. 2 diagrammatically illustrates a flat representation of the decorated parse tree of FIG. 1, according to a first particular embodiment of the invention,

FIG. 3 illustrates a flat representation of the decorated parse tree of FIG. 1, according to a second particular embodiment of the invention,

FIGS. 4A and 4B illustrates two examples of a first data structure of a specific rule of the source program of FIG. 1, according to particular embodiments of the invention,

FIG. 5 diagrammatically illustrates the compiling of the source program of FIG. 1 to be executed on a target environment, according to a particular embodiment of the invention,

FIG. 6 diagrammatically illustrates a device implementing a method for compiling the source program of FIG. 1, according to a particular embodiment of the invention,

FIG. 7 shows a method for compiling the source program of FIG. 1, implemented in the device of FIG. 6, according to a particular embodiment of the invention.

### 5. DETAILED DESCRIPTION OF EMBODIMENTS OF THE INVENTION

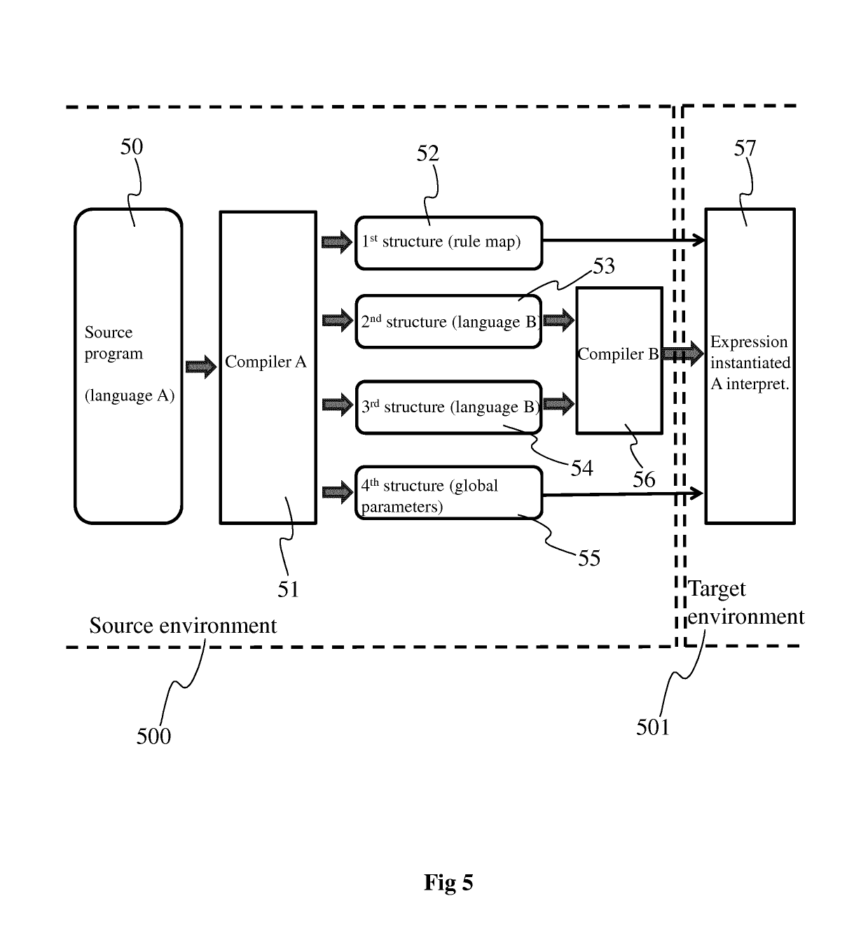

FIG. 5 illustrates the translation of a source program or source code 50 into a target language for execution on a target environment, according to a particular and non limitative embodiment of the invention. The target language, called language B, is for example HLSL (High Level Shader Language) language or GLSL (OpenGL Shading Language) when the target environment uses one or more GPUs for running the executable program resulting from the translation of the source program. The source program 50 is written in a first programming language (called language A), the language A being advantageously a high-level programming language. In contrast to machine language or low-level programming language, the high-level programming language enables the use of natural language elements, i.e. elements with strong abstraction from the details of the computing device on which the source program will be executed. The source program 50 comprises one or more rules which are not natively supported by the target environment. The source program 50 comprises for example a procedural description of object(s) to be rendered, for example for the generation of buildings. By procedural description of the object(s) is understood the definition of a grammar that comprises a set of rule expressions (also called parameters) and a set of generation rules.

At a first stage, the source program 50 is compiled by a compiler A 51 and transformed into several data structures, also called libraries. The data structures comprise a first data structure 52, a second data structure 53, a third data structure 54 and a fourth data structure 55. Naturally, the number of data structures at the output of the compiler A 51 is not limited to 4 but also extends to any number. For example, the second and third data structures may be combined and output under the form of a single data structure. According to a variant, the different data structures are parts of a same library or file output from the compiler A 51.

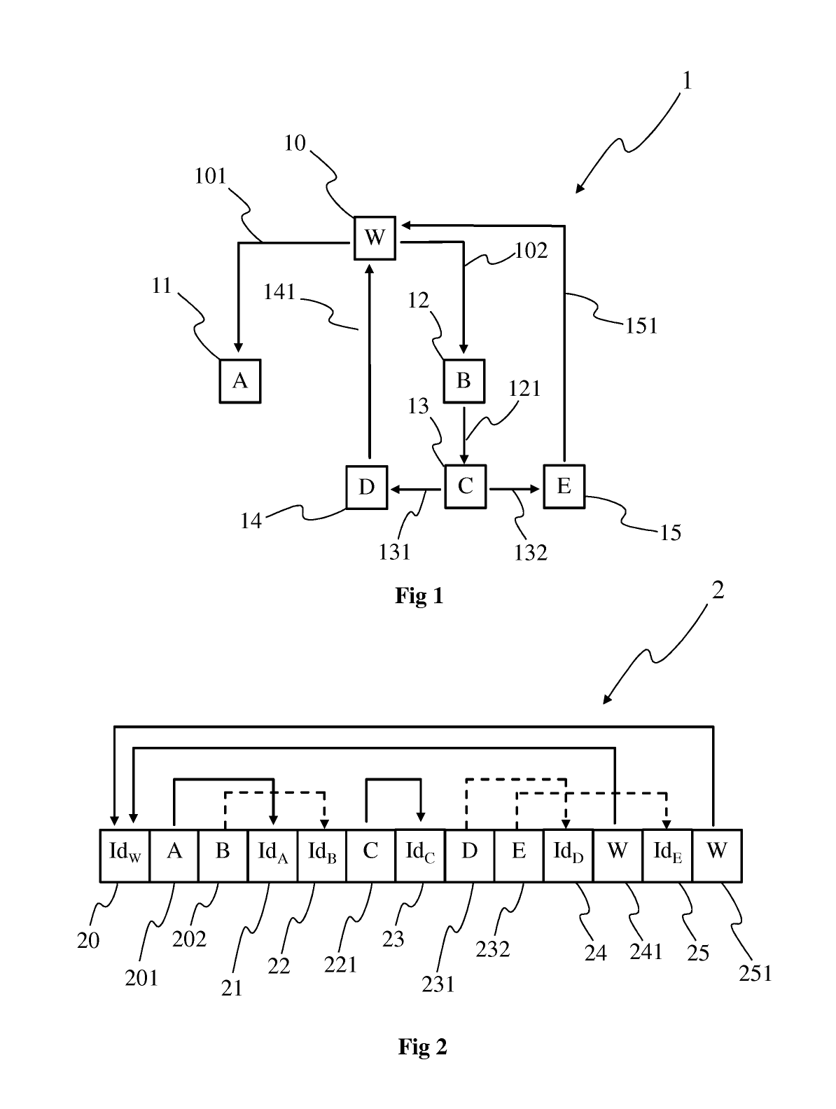

The compiler A 51 advantageously comprises a lexical analyzer performing a lexical analysis of the source program 50, the source program 50 being divided into small pieces of code called token during the lexical analysis. The compiler A 51 also comprises one or more parser performing syntax analysis and semantic analysis during parsing processes. The syntax analysis enables to identify the syntactic structure of the program by parsing the sequence of tokens. During the syntax analysis, a parse tree is formed, replacing the linear sequence of tokens. Then, semantic analysis is performed to add semantic information to the parse tree, the result of the semantic analysis being a decorated parse tree (also called abstract syntax tree), as illustrated on FIG. 1. The nodes of the decorated parse tree correspond to the rules of the source program, a unique Identifier (ID) being associated to each one of the rules. During the parsing process, rules expressions are extracted from the source program, are assigned a unique identifier (ID) and are positioned in the decorated parse tree at the level of each rules associated with these expressions.

The compiler A 51 also comprises a code generator performing code generation. The first 52, second 53, third 54 and fourth 55 data structures are generated during the code generation process:
the first data structure 52 is obtained from the decorated parse tree and corresponds to a flat representation of the decorated parse tree. The first data structure takes the form of a map (also called rule map as it comprises references to the rules of the source program) is composed of a linear sequence of fields, some of the fields comprising the unique identifiers identifying the rules of the decorated parse tree. Rules expressions and parameters associated with the rules are also identified in the first data structure through their unique identifiers. The unique identifiers corresponds advantageously to integer numbers, which enables to transmit the first data structure 52 to the target environment for runtime without any further compilation process.
the second data structure 53 comprises a first set of instructions written/coded in the language B. The first set of instructions enables to read the first data structure 52 at runtime and to interpret the rules identified in the first data structure 52. The second data structure 53 may also be called ‘A Interpreter’ as it enables the target environment to read and interpreter the rules of the source program 50 written in the language A. To that aim, the first set of instructions comprises for example a library of functions of the target language B (for example GLSL), also called built-in functions, corresponding to the code in language B of each rule of the language A, one or several functions of the code B being used to interpret one rule of the language A. The first set of instructions also comprises a function in language B used to read the first data structure 52 at runtime. The second data structure 53 is dependent from the target environment as it comprises built-in functions, which are interpretable, directly or indirectly, by the target environment. During the code generation process, the code generator detects the rules in language A to be used via their unique identifiers in the decorated parse tree and adds the corresponding functions in language B in the second data structure 53. Thus, a rule written in language A (for example high-level language rule) may be interpreted by the target environment (for example a pipeline or part 57 of a pipeline of a GPU) with the functions of language B (built-in functions) comprised in the second data structure 53.
the third data structure 54 comprises a second set of instructions written/coded in the language B and is thus dependent from the target environment. The first set of instructions enables to interpret the rules expressions identified in the first data structure 52. During code generation process, the rules expressions are encapsulated in functions of the language B comprising a switch. Then, at runtime on the target environment, values associated with the rules expressions are retrieved by using the unique identifier associated to each of them.
the fourth data structure 55 comprises a set of global parameters extracted from the source program 50. A global parameter corresponds to a parameter that may be used by several different rules and may be modified at runtime on the target environment. A global parameter advantageously corresponds to a parameter of the third data structure 54 and declared as such in the third data structure 54 with code of language B. The fourth data structure advantageously takes the form of a map, comprising for example N lines (N≧0) if N is the number of global parameters and M columns (M≧1), M being the number of values taken by each global parameter to be applied to the M procedural seeds on which the source program 50 are applied. A procedural seed corresponds advantageously to a group of initial geometries (for example a line or a triangle or a quadrilateral) to be developed with the procedural rules, the global parameter(s) may vary at runtime according to the initial geometry. The fourth data structure 55 is transmitted as such to the target environment. The fourth data structure 55 is read and interpreted at runtime on the target environment by using a function of the language B added to the third data structure 54.

The source environment 500 on which runs the compiler A 51 is advantageously different from the target environment. The compiler A 51 is called cross-compiler as it enables to translate a source code written in the language A to an executable program in a language B running on the target environment different from the source environment.

Advantageously, the second 53 and third 54 data structures are compiled by a compiler B 56 at a second stage before being transmitted to the target environment. The compiler B 56 enables to translate the data structures 53 and 54 comprises code instructions in language B in a machine language, for example a binary code, directly interpretable by the processor of the target environment 501. According to a variant, the second 53 and third 54 data structures are transmitted directly to the target environment 501 without being compiled by the compiler B 56, the language B being itself a machine language directly interpretable by the processor of the target environment.

In an advantageous way, the source environment 500 is different from the target environment 501. As an example, the source environment 500 comprises one or several CPU(s) (Central Processing Unit(s)) and the target environment 501 comprises one or several GPU(s) (Graphics processing Unit(s)). According to a variant, the source environment 500 and the target environment 501 are different in the sense that they use different operating systems.

FIG. 1 shows a source program under the form of a decorated parse tree 1, also called abstract syntax tree, according to a particular and non limitative embodiment of the invention. The decorated parse tree 1 is advantageously a directed graph as a direction is associated with the branches 101, 102, 121, 131, 132, 141, 151 linking two nodes 10, 11, 12, 13, 14, 15. According to the example of FIG. 1, the directed graph 1 comprises six nodes W 10, A 11, B 12, C 13, D 14 and E 15, each node corresponding to a rule. Each rule or grammar rule may be generically written with the following formulation:

Pred→Rule({Exprⱼ(P) [symbol] ){Succ}

wherein Pred is the predecessor of the rule, Rule is the name of the grammar rule and Succ is the set of at least one successor of the rule. Using this formulation, a rule is represented by using four components: a predecessor, a successor set, a rule type and a set of expressions representing the arguments related to the rule type.

According to the example of FIG. 1, the rule W 10 is the predecessor of the rules A 11 and B 12; the rule B 12 is the predecessor of the rule C 13; the rule C 13 is the predecessor of the rules D14 and E 15; the rule D14 is a first predecessor of the rule W 10 and the rule E 15 is a second predecessor of the rule W 10. The rules A 11 and B 12 are the successors of the rule W 10; the rule C 13 is the successor of the rule B 12; the rule D14 and E 15 are the successors of the rule C 13; the rule W 10 is the successor of each rule D 14 and E 15. The directed graph 1 illustrates a recursive process (for example a recursive growth of a tree) which is typically not natively supported by a GPU. By using the formulation above, the rules W, A, B, C, D and E are expressed as follow:

W→Extrude(10)(A,B)

A→22 Shape(shapeId)

B→Cond(reclevel<n)(C,Ø)

C→Branch{D,E}

D→Rotate(−π/4)(W)

E→Rotate(π/4)(W)

Naturally, the number of rules is not limited to five but also extends to any number greater than or equal to 1.

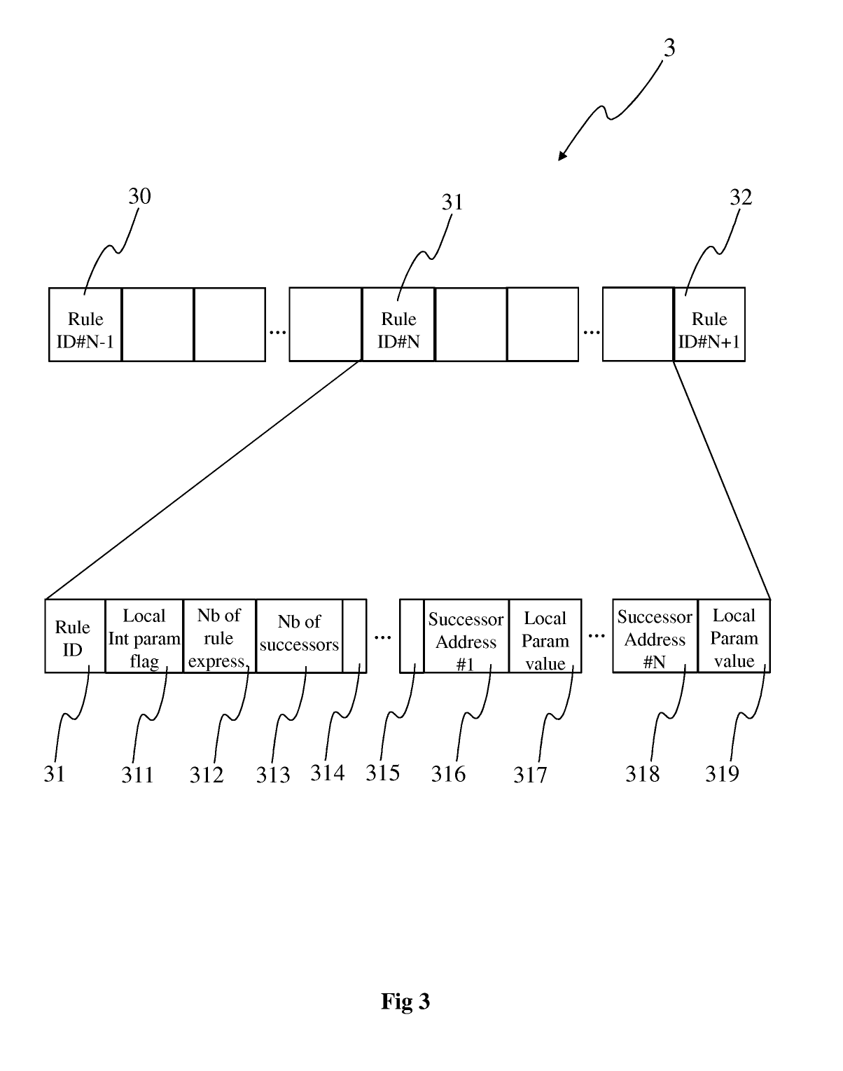

FIG. 2 illustrates a flat representation 2 of the decorated parse tree 1, according to a first specific and non limitative embodiment of the invention. The flat representation 2 comprises a plurality of fields, the fields being associated with the rules type and the successors of the directed graph 1. The flat representation 2 comprises a first field 20 comprising an identification value Id_{w} identifying the rule type W. The first field 20 is followed by a second field 201 comprising a pointer A pointing to the fourth field 21, which comprises an identification value Id_{A} identifying the rule type A. According to a variant, the second field 201 comprising the address of the fourth field 21. The second field 201 is followed by a third field 202 comprising a pointer B pointing to the fifth field 22, which comprises an identification value Id_{B} identifying the rule type B. According to a variant, the third field 202 comprises the address of the fifth field 22. The first field associated with the rule type W is thus followed by two fields each associated with a pointer (or an address) pointing to the successors of W, i.e. A and B. As the rule A has no successor, the fourth field 21 may be followed by the fifth field 22 to which is associated the identification value Id_{B} identifying the rule type B. C being the successor of B, the fifth field 22 is followed by the sixth field 221 comprising a pointer C pointing to the seventh field 23, which comprises an identification value Id_{c} identifying the rule type C, the identifying value Id_{c} being comprised in the eighth field 23 following the seventh field 221. D and E being the successors of C, the seventh field 23 is followed by the eighth field 231 comprising a pointer D pointing to the tenth field 24, which comprises an identification value Id_{D} identifying the rule type D, and by the ninth field 232 comprising a pointer E pointing to the twelfth field 25, which comprises an identification value Id_{E} identifying the rule type E. W being the successor of D and E, the tenth field 24 is followed by the eleventh field 241 comprising a pointer W pointing to the first field 20, which comprises the identification value Id_{w} identifying the rule type W and the twelfth field 25 is followed by the thirteenth field 251 comprising a pointer W pointing to the first field 20, which comprises an identification value Id_{w} identifying the rule type W. A field comprising an identification value associated with a rule type is thus followed by one or more fields each associated with a pointer to (or an address of) the field comprising an identification value associated with the successor of the rule type, when at least a successor exists. The link between the field comprising a pointer and the field toward which the pointer points is illustrated with an arrow on FIG. 2. The use of pointer pointing to field(s) associated with successor(s) of a rule type in the flat representation enables to create loop (or recursion) between different rules or even to create a loop looping on a same and single rule. To that aim, a field of the flat representation associated with an identification value of a given rule has just to be followed by a field comprising a pointer pointing to the field comprising the Id of the given rule.

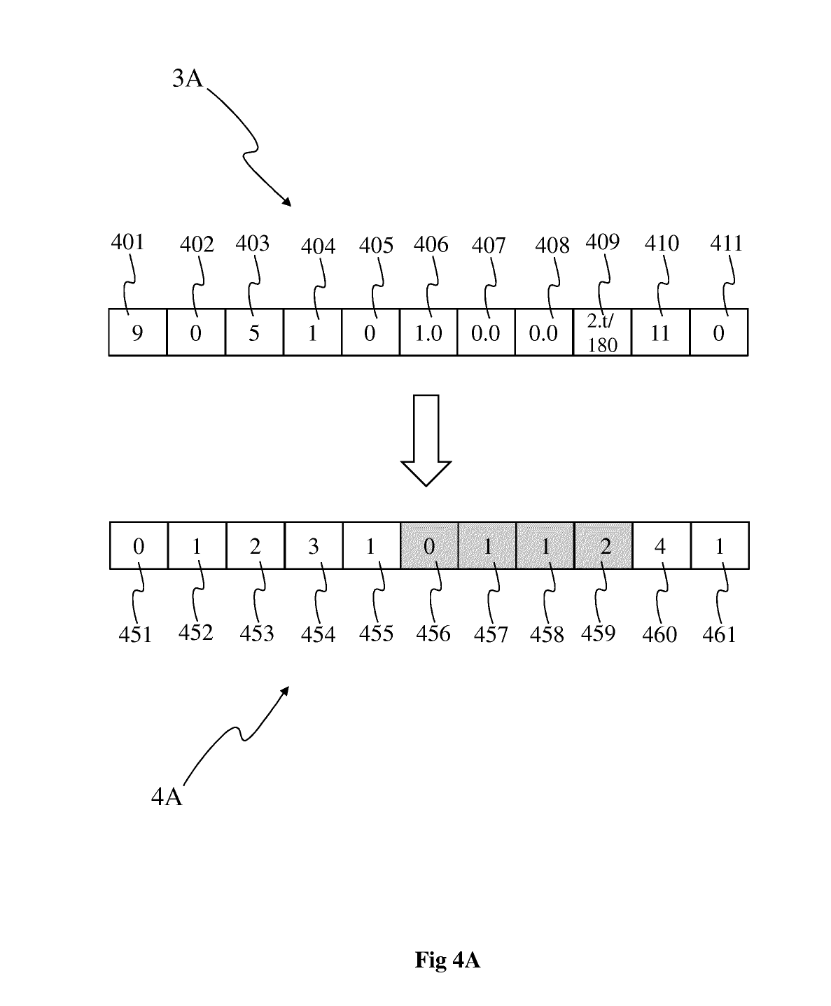

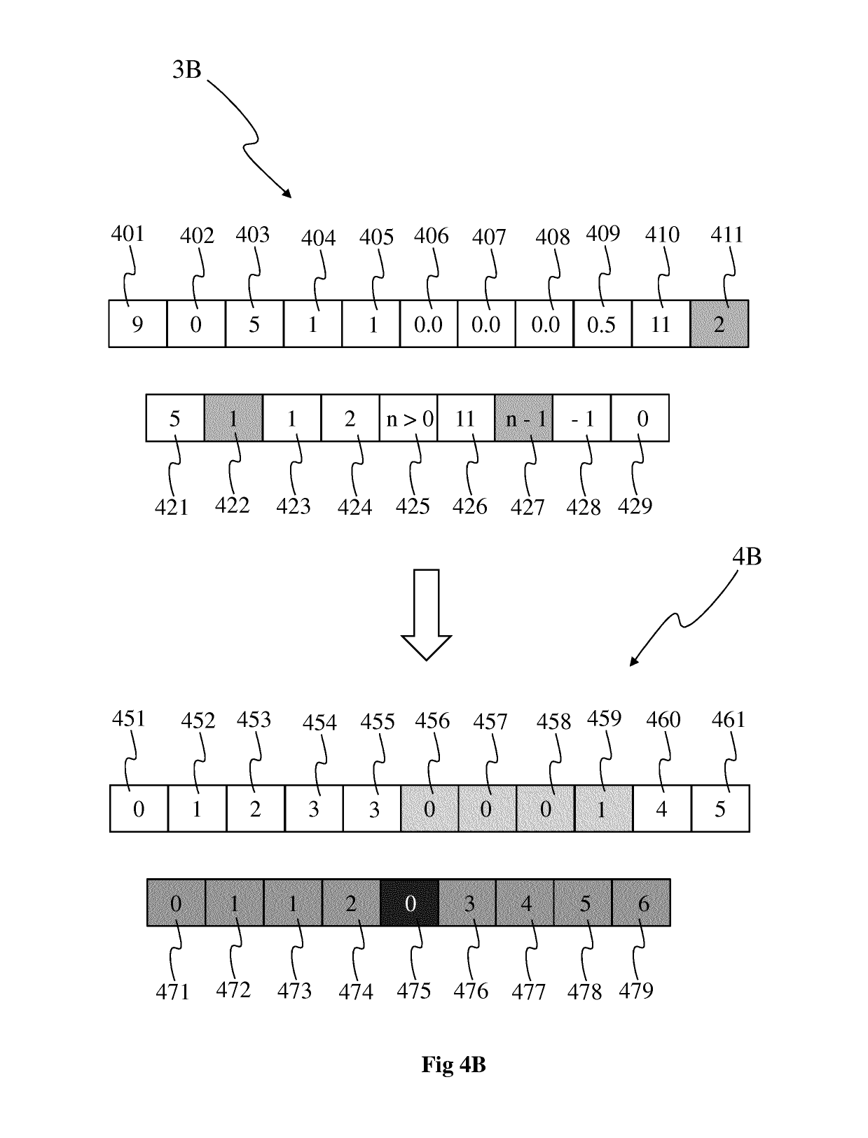

FIG. 3 illustrates a flat representation 3 of the directed graph 1, according to a second specific and non limitative embodiment of the invention. The flat representation 3 comprises a series of fields, some of the fields 30, 31 and 32 comprising identification values associated with the rules of the directed graph. Depending on the rule type, each of these fields 30, 31 and 32 is itself followed by zero, one or more other fields. Bottom part of FIG. 3 provides with an illustration of the fields of the flat representation associated with the rule identified in the field 31 via the Rule ID. Field 31 is followed by the field 311, which comprises a local internal parameter flag, this flag taking the value 0 or 1, value 0 being taken when no local internal parameter is associated with the rule identified via its Rule ID 31, value 1 being taken when one or more local internal parameters are associated with the rule identified by the Rule ID 31. The local internal parameter flag is advantageously used as to implement recursive function, as explained with more details with regard to FIG. 4B. Field 311 is followed by the field 312, which comprises the number of rule expression(s) associated with the rule, this number being any integer starting from 0, 0 included. Field 312 is then followed by the field 313 comprising the number of successor(s) associated with the rule identified via the Rule ID 31. The number of successor is any integer starting from 0, 0 included. Fields 314 and 315 comprises the values taken by the rule expressions, the number of which being declared in the field 312. The number of fields comprising the rule expressions corresponds to the number of rule expressions declared in the field 312. Advantageously, one of the rule expressions is a parametric expression, the parameter of the parametric expression(s) being for example a global parameter, the value of the global parameter varying at runtime. Then, according to the number of successor(s), some fields 316, 318, the number of which corresponding to the number of successor(s) indicated in field 313, each comprise a pointer or an address pointing to the field of flat representation 3 comprising the Rule ID associated with the rule type corresponding to this successor. The pointer or the address may corresponds for example to a number, given that each and every field of the flat representation is associated with a sequential number, 0 being associated with the first field of the flat representation, 1 to the second field following the first one, 2 to the third field following the second one and so on. Each of the fields 316, 318 comprising a pointer (or an address) to a field indentifying a successor rule is followed by a field, respectively 317 and 319, comprising the value of the local parameter of the successor rule.

FIGS. 4A and 4B each illustrate one example of a first data structure representing a first rule of the source program.

FIG. 4A illustrates a flat representation 3A and a first data structure 4A corresponding to a rule of the type ‘Rotate’, the top part 3A of FIG. 4A corresponding to the flat representation described with regard to FIG. 3 with values and parameters associated with the rule type ‘Rotate’, such a rule generating the rotation of a geometrical element, for example a line or a mesh element such as a triangle or a quadrilateral. The field 401 of the flat representation 3A comprises an identification of the rule type and takes the value ‘9’ according to this example, the rule type ‘9’ being thus associated with ‘Rotate’. The field 402 corresponds to the local internal parameter flag and takes the value ‘0’ according to this example, which means that no local internal parameter is associated with this rule ‘Rotate’. Otherwise, if a local internal parameter would be associated with this rule ‘Rotate’, the flag would take the value ‘1’. The field 403 corresponds to the number of rule expressions associated with this rule ‘Rotate’ and takes the value ‘5’ according to this example, which means that there are 5 rule expressions associated with this rule ‘Rotate’. The field 404 corresponds to the number of successors associated with this rule ‘Rotate’ and takes the value ‘1’ according to this example, which means that there is 1 successor associated with this rule ‘Rotate’. The field 405 corresponds to the first one of the 5 rule expression associated with this rule ‘Rotate’ and takes the value ‘0’ according to this example. This first rule expression corresponds for example to a flag indicating whether a local normal is used as rotation axis, i.e. if the normal vector of current base is used or not as rotation axis. If the value is ‘0’, then the local normal is not used as rotation axis and if the value is ‘1’, then the local normal is used as rotation axis. When the use local normal flag of field 405 takes the value ‘0’, then the following fields 406, 407 and 408 each takes a value corresponding to the coordinates of the axis vector. The field 406 corresponds for example to the x component of the coordinate of the axis vector and takes the value ‘1.0’ according to this example; the field 407 corresponds for example to the y component of the coordinates of the axis vector and takes the value ‘0.0’ according to this example; and the field 408 corresponds for example to the z component of the coordinate of the axis vector and takes the value ‘0.0’ according to this example. Fields 406, 407 and 408 correspond to the second, third and fourth rule expressions associated with this rule ‘Rotate’. The field 409 corresponds to the fifth and last one of the 5 rule expressions associated with this rule ‘Rotate’ and takes the value ‘2*t/180’ according to this example, which corresponds to the rotation angle associated with this rotation. T corresponds advantageously to a global parameter extracted from the source program during compiling process, the global parameter being transmitted directed to the GPU without any further processing. A global parameter corresponds to a parameter that may be used by several different rules and may be modified at runtime on the GPU. The filed 410 corresponds to the successor address or to the pointer to the successor and takes the value ‘11’ according to this example, ‘11’ corresponding to the position of the rule corresponding to the successor of this rule ‘Rotate’, i.e. the 12^{th} field of the flat representation 3 when 0 is associated with the first field of the flat representation 3 (the position of a field in the flat representation 3 corresponding to an incremental integer starting from 0, position 11 thus corresponding to the 12^{th} field). Then, the field 411 corresponds to the value of the local internal parameter associated with the successor, the address of which being in the preceding field 410. According to this example, the successor of the rule ‘Rotate’ identified in the field 410 has no local parameter and it takes the value ‘0’. Otherwise, this field 411 would take the value ‘1’.

The structure of the flat representation 3A of a rule is advantageously associated with the type of the rule, only the values taken by the fields varying from a rule to another one for rules of the same type.

The flat representation 3A of the rule ‘Rotate’ is not usable as it is by the GPU as at least one of the field of the flat representation comprises a parametric expression, i.e. an expression being expressed with a parameter, for example a global parameter, the value of which may vary at runtime. Indeed, for interpreting such a parametric expression at runtime, it is necessary to generate a function in language B able to compute the parametric expressions and it is then necessary to identified it via an identifier. In the example of the flat representation 3A, the field 409 comprises such a parametric expression with t as global parameter. A first data structure 4A is either obtained from the flat representation of the rule ‘Rotate’ during the compiling process of the source program or obtained directly from the source program during the compiling process performed in the compiler A. During this process, a unique identifier (ID) is assigned to each of the fields of the flat representation 3A, the identifier depending on the value type taken by the fields 401 to 411. Depending on whether the values of the fields 401 to 411 are of the integer type or floating type or Boolean type, a unique identifier is assigned to this values, the identifiers (IDs) corresponding advantageously to integer values series, one series being associated with a particular type (integer, float or Boolean). The choice of integer values for the IDs offer the advantage of an easy and quick reading at runtime in comparison to more complicated and diversified identifiers. Nevertheless, if the first data structure only comprises values in the fields 401 to 411, the invention may be implemented without identifying the values comprised in these fields, the flat representation 3A corresponding to the first data structure according to this variant.

The values ‘9’, ‘0’, ‘5’, ‘1’, ‘0’, ‘11’ and ‘0’ of respectively the fields 401, 402, 403, 404, 405, 410 and 411 being of the integer type, they are assigned a first series of IDs, respectively the IDs ‘0’, ‘1’, ‘2’, ‘3’, ‘1’, ‘4’ and ‘1’, as illustrated in the fields 451, 452, 453, 454, 455, 460 and 461 of the second flat representation 4A. As values of fields 402, 405 and 411 are of the same type (integer) and equal (0′), they have the same ID ‘1’ in the first data structure 4A. The values ‘1.0’, ‘0.0’, ‘0.0’ and ‘2*t/180’ of respectively the fields 406, 407, 408 and 409 being of the float type, they are assigned a second series of IDs, respectively the IDs ‘0’, ‘1’, ‘1’ and ‘2’, as illustrated in the fields 456, 457, 458 and 459 of the first data structure 4A. As values of fields 407 and 408 are of the same type (float) and equal (‘0.0’), they have the same ID ‘1’ in the second flat representation 4A. In a series, the first ID is 0 and any new ID is computed by adding 1 to the previous computed ID as to form a series of successive integers.

As to interpret the first data structure 4A at runtime on the target environment and as explained with regard to FIG. 5, a second data structure and a third data structure are generated during the compiling of the source program. The third data structure comprises functions of a target language B associated with the target environment, for example GLSL for a GPU. The third data structure comprises at least an instruction in language B enabling to retrieve the values associated with the first rule expressions by using the IDs of the first data structure identifying the rules expressions. Below is an example of code in GLSL using two switch functions for retrieving the values of the expressions when the first data structures is executed at runtime on a GPU:

```
// integer expression functions
int _e_i0( ) { return 9;}
int _e_i1( ) { return 0;}
int _e_i2( ) { return 5;}
int _e_i3( ) { return 1;}
int _e_i4( ) { return 11;}
int _evalIntegerExpression( int id )
{
  switch (id) {
    case 0: return _e_i0( );
    case 1: return _e_i1( );
    case 2: return _e_i2( );
    case 3: return _e_i3( );
    case 4: return _e_i4( );
  }
}
// float expression functions
float _e_f0( ) { return 1.0;}
float _e_f1( ) { return 0.0;}
float _e_f2( ) { return 2.0*t/180.0;}
float_evalFloatExpression( int id )
{
  switch (id) {
    case 0: return _e_f0( );
    case 1: return _e_f1( );
    case 2: return _e_f2( );
  }
}
```

As can be seen from this example of GLSL code, one switch function is used for each type of series of IDs, i.e. for the integer type and for the float type expressions, which enable to retrieve the value associated with each one of the two integer series of IDs.

The second data structure comprises a set of instructions in language B usable by the processor of the target environment to interpret the first rule of the source program, which id identified via a unique ID in the first data structure, the unique ID identifying the rule type of the rule. According to the example of FIG. 4A, the ID of the first data structure identifying the first rule is ‘0’, and the rule type value identified is ‘9’. The second data structure comprises a set of instructions in the target language B (for example GLSL) used to read and interpret the first rule in source language A. Below is an example of code in GLSL using GLSL functions that are used for interpreting the first rule ‘Rotate’ having the rule type ‘9’ when the first data structures is executed at runtime on a GPU:

```
void main( )
{
  // initializes the stacks of vertex position, texture coords, local base,
childIndex,..
  // initializes the global parameters
  _initialize( )
  // main loop to read and interpret the first data structure with depth
left first traversal order
  int depthIndex = 0;
  childIndex[0] = 0; // used for the traversal
  grammaIndex[0] = 0; // used for the traversal: stores the current
index of the level
  bool goToAboveLevel = false; // used for the traversal
  while ( depthIndex > −1 )
  {
    // retrieves the ruleID by using the IDs associated with the
field comprising the rule ID
    int ruleID = _evalIntegerExpression(
ruleMap[grammaIndex[depthIndex]] );
    // retrieves the number of local parameter (0 or 1)
    int nbOfLocalParam =
_evalIntegerExpression(ruleMap[grammaIndex[depthIndex] + 1] );
    // retrieves the number of rule expressions
    int nbOfRuleParam =
_evalIntegerExpression(ruleMap[grammaIndex[depthIndex] + 2] );
    // retrieves the number of successors
    int nbOfSuccessors =
_evalIntegerExpression(rulemap[grammaIndex[depthIndex] + 3] );
    // switch on the right rule interpreter based on the rule ID
    switch ( ruleID )
{
      case 9: // Rotate rule
      {
          // checks if all its successors have been evaluated
          if (childIndex[depthIndex ] == nbOfSuccessors ) {
            goToAboveLevel = true;
          }
          else {
            // retrieves the axis and angle rotation parameters
            (i=4,5,6,7,8)
            param = _evalFloatExpression
(ruleMap[grammaIndex[depthIndex] + i] );
            // performs the rotation of the vertices and the local base
            //  vector located on the top of their stack
            // sets the grammar index to the next grammar level (rule
successor)
            depthIndex += 1;
            grammaIndex[depthIndex] =
ruleMap[grammaIndex[depthIndex− 1]+9];
            childIndex[depthIndex ]= 0;
            // defines the stacks for the next grammar level
            (rule successor)
          }
      }
    }
      if (goToAboveLevel ) {
            depthIndex −= 1;
            childIndex[depthIndex ]=++;
            goToAboveLevel = false;
      }
  } // end of rule map traversal
}
```

As can be seen from this example of GLSL code, the program comprises a first part for initializing the parameters; a second part for travelling through the first data structure and retrieving the IDs identifying the rule type (vie the use of the function _evalIntegerExpression) and retrieving the IDs identifying the respective numbers of local parameter, rule expressions and successors; and a third part for finding the GLSL functions (via a switch function type) to be used for interpreting the rule of the rule type ‘9’, i.e. the rule rotate.

FIG. 4B illustrates a flat representation 3B and a first data structure 4B corresponding to a rule of the type ‘Rotate’, the top part 3A of FIG. 4A corresponding to the flat representation described with regard to FIG. 3 with values and parameters associated with the rule type ‘Rotate’. The fields 401 to 411 of the flat representation 3B corresponds to the same fields in FIG. 4A, only the values associated to these fields being different between FIG. 4B and FIG. 4A. The fields 401 to 411 of the flat representation 3B takes respectively the values ‘9’ (ID of the rule type of the rule ‘Rotate’), ‘0’ (no local internal parameter associated with this rule ‘Rotate’), ‘5’ (number of rule expressions associated with this rule ‘Rotate’), ‘1’ (number of successors of this rule ‘Rotate’), ‘1’ (use of the normal vector of the current base for the rotation), ‘0.0’ (x coordinates of the rotation axis, not used as the normal vector is used), ‘0.0’ (y coordinates of the rotation axis, not used as the normal vector is used), ‘0.0’ (z coordinates of the rotation axis, not used as the normal vector is used), ‘0.5’ (rotation value in radian of this ‘Rotate’ rule), ‘11’ (pointer/address of the successor of this rule ‘Rotate’) and ‘2’ (internal parameter associated with the successor rule and taking the value 2).

The fields 421 to 429 correspond to the flat representation of the successor rule of the rule ‘Rotate’ represented with the fields 401 to 411, this successor rule being according to this particular example a ‘Condition’ rule. The first field 421 comprises a value equal to ‘5’ corresponding to the rule type ID of the rule ‘Condition’. The second field 422 comprises a value ‘1’ corresponding to the value taken by the local internal parameter flag, which means that a local internal parameter is associated with this rule ‘Condition’. The third field 423 comprises a value equal to ‘1’ corresponding to the number of rule parameter associated with this rule ‘Condition’. The fourth field 424 comprises a value equal to ‘2’ corresponding to the number of successors associated with this rule ‘Condition’. The fifth field 425 comprises a parametric expression ‘n>0’ of the Boolean type, i.e. returning only 2 values, for example either ‘true’ or ‘false’. The fifth field comprises the unique expression associated with this rule ‘Condition’ and declared in the field 423. The sixth field 426 comprises a value equal to ‘11’ corresponding to the pointer/address to the first successor, the first successor being the rule ‘Condition’ itself as 11 corresponds to the position of this rule in the global flat representation of the whole decorated parse tree of the source program. The seventh field 427 comprises the local parameter value ‘n−1’ associated with the first successor having the address ‘11’. The eighth field 428 comprises a value equal to ‘−1’ corresponding to the pointer/address of the second successor associated with this rule ‘Condition’. The ninth field 429 comprises a value equal to ‘0’ corresponding to local parameter value associated with the second successor, the address of which being comprised in the eighth field 428. Such a structure for the rule ‘Condition’ enables to implement a loop based on the checking of a condition, i.e. based on the checking of n>0. The first successor is called when the condition is satisfied (when n>0) and the second successor is called when the condition is not satisfied (n=0 for example). At runtime, the condition n>0 is checked and the successor is chosen according to the result of the checking. The first successor (the rule ‘Condition’ itself according to this simple example) is chosen as long as n>0 and the parameter n is decreased of ‘1’ each time the first successor is called (n starting with a value equal to 2 as defined in the field 411 of the rule ‘Rotate’). The second successor corresponds to the null element. After two iterations, the programs stop by outputting nothing. The use of a local internal parameter (declared with the flag 422) in association with the Boolean expression for checking a condition and the internal parameter associated with first successor enables to implement a recursion or a loop (via the use of a stack with the parameter n) without repeating this recursive function ‘Condition’ two times in the body of the program.

In the same way as with regard to FIG. 4A, the flat representation 3B of the rules ‘Rotate’ and ‘Condition’ is expressed with series of integer identifiers (IDs) identifying each of the values of the fields 401 to 411 and 421 to 428. Each type of values (integer, local integer, float and local Boolean) is assigned a series of integer IDs, a unique ID being assigned to a same value of the same type. Integer values of the fields 401, 402, 403, 404, 405, 410 and 411 are assigned the respective integer IDs ‘0’, ‘1’, ‘2’, ‘3’, ‘3’, ‘4’ and ‘5’ in the corresponding fields (white fields) 451, 452, 453, 454, 455, 460 and 461 of the first data structure 4B. Float values of the fields 406, 407, 408 and 409 are assigned the respective integer IDs ‘0’, ‘0’, ‘0’ and ‘1’ in the corresponding fields (light grey fields) 456, 457, 458 and 459 of the first data structure 4B. Local integer values of the fields 421, 422, 423, 424, 426, 427, 428 and 429 are assigned the respective integer IDs ‘0’, ‘1’, ‘1’, ‘2’, ‘3’, ‘4’, ‘5’ and ‘6’ in the corresponding fields (grayed fields) 471, 472, 473, 474, 476, 477, 478 and 479 of the first data structure 4B. Local Boolean value of the field 426 is assigned the respective integer ID 0 in the corresponding field (black field) 475 of the first data structure 4B. Thus, the first data structure 4B identifies each value of the flat representation of the source program with an integer ID according to the type of the value, which enables a simple and quick reading of the first data structure at runtime, the interpretation of which being performed with the second and third data structure as explained with regard to FIG. 4A.

An example of the second data structure (in GLSL code) usable for interpreting the first data structure 4B is as follow:

```
        void main( )
        {
          // integer stack to manage recursivity
          int localIntStack[100];
          // initializes the stacks of vertex position, texture coords,
local base, childIndex,..
          // initializes the global parameters
          _initialize( )
          // main loop to interpret the first data structure with depth
left first traversal order
          int depthIndex = 0;
          childIndex[0] = 0; // used for the traversal
          grammaIndex[0] = 0; // used for the traversal: stores the
current index of the level
          localIntStack[0] = 0;
          bool goToAboveLevel = false; // used for the traversal
          while ( depthIndex > −1 )
          {
            // retrieves the ruleID (rule type) via the integer ID
            int ruleID = _evalIntegerExpression(
ruleMap[grammaIndex[depthIndex]] );
            // retrieves the nb of local parameter (0 or 1) to know
which function to use
            int nbOfLocalParam =
_evalIntegerExpression(ruleMap[grammaIndex[depthIndex] + 1] );
            // retrieves the nb of rule parameters
            int nbOfRuleParam =
_evalIntegerExpression(ruleMap[grammaIndex[depthIndex] + 2] );
            // retrieves the nb of successors
            int nbOfSuccessors =
_evalIntegerExpression(rulemap[grammaIndex[depthIndex] + 3] );
            // retrieves the current local int value
            int localInt = localIntStack[depthIndex];
            // switch on the right rule interpreter
            switch ( ruleID )
          {
              case 5: // Condition rule
              {
                // checks if its valid successors has been evaluated
                if (childIndex[depthIndex ] == 1 ) {
                  goToAboveLevel = true;
                }
                else {
                  // retrieves the Boolean expression using the
appropriate function
                  bool expressionValue = false;
                  if ( nbOfLocalParam == 1) // needs (ID,n) to
retrieve the expressionValue
                    expressionValue =
                    _evalLocalBooleanExpression(
                          ruleMap[grammaIndex[depthIndex] +
4] , localInt );
                  else
                    expressionValue = _evalBooleanExpression(
                          ruleMap[grammaIndex[depthIndex] +
                          4] );
                  // selects the right successor depending on the
expressionValue
                  // sets the grammar index to the next grammar
level (rule successor)
                  depthIndex += 1;
                  grammaIndex[depthIndex] =
ruleMap[grammaIndex[depthIndex−1]+i];
                  childIndex[depthIndex ]= 0;
                  localIntStack[depthIndex−1] =
_evalLocalIntegerExpression(
                              ruleMap[grammaIndex[depthIndex−
1]+i+1] , localInt );
                  // defines the other stacks for the next grammar
level (rule successor)
                }
              }
          }
              if (goToAboveLevel ) {
                depthIndex −= 1;
                childIndex[depthIndex ]=++;
                goToAboveLevel = false;
              }
          } // end of rule map traversal
}
```

Naturally, the number of iterations is not limited to 2 but also extends to any number greater than or equal to 2, the number of iterations being declared in the rule (i.e. the rule “calling” the successor rule associated with the number of iterations) in the internal parameter field associated with the successor(s) of the rule.

The use of a local parameter associated with the successor rule (called by the first rule, i.e. the rule ‘Rotate according to the example) enable the implementation of a stack which enables to implement recursion or loop. The interpreter (the second data structure) may be called stack-based interpreter. For each rule, the stack-based interpreter evaluates the expressions associated with the rule and applies the corresponding rule to determine the successor set. The successor is then recursively processed.

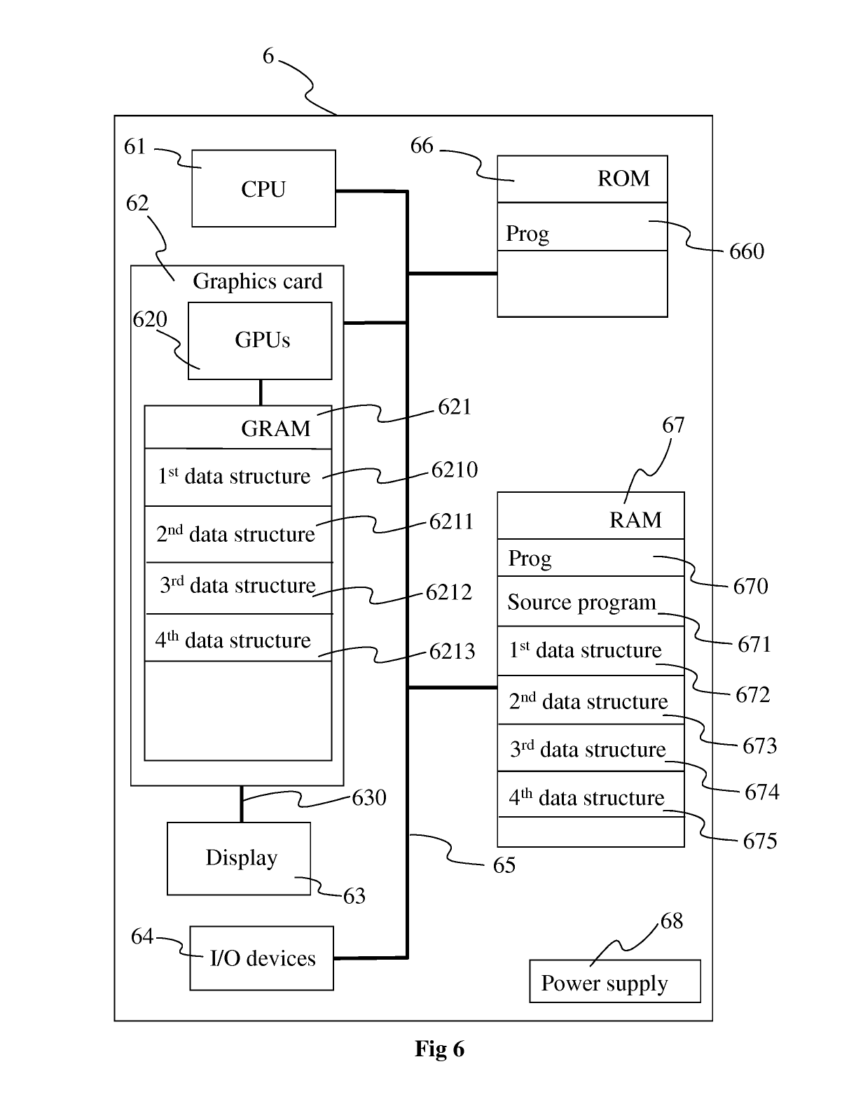

FIG. 6 diagrammatically shows a hardware embodiment of a device 6 adapted for the compiling of a source program 50. The device 6 corresponds for example, to a PC personal computer, a laptop or a games console.

The device 6 comprises the following elements, connected to each other by a bus 65 of addresses and data that also transports a clock signal:
a microprocessor 61 (or CPU),
a graphics card 62 comprising:
   several Graphical Processor Units (or GPUs) 620,
   a Graphical Random Access Memory (GRAM) 621,
a non-volatile memory of ROM (Read Only Memory) type 66 comprising any program 660,
a Random Access Memory or RAM 67,
one or several I/O (Input/output) devices 64 such as for example a keyboard, a mouse, a webcam, and
a power source 68.

The device 6 also comprises a display device 63 of display screen type directly connected to the graphics card 62 to display notably the display of synthesized images calculated and composed in the graphics card, for example live. The use of a dedicated bus to connect the display device 63 to the graphics card 62 offers the advantage of having much greater data transmission bitrates and thus reducing the latency time for the displaying of images composed by the graphics card. According to a variant, the display device is external to the device 6. The device 6, for example the graphics card, comprises a connector adapted to transmit a display signal to an external display means such as for example an LCD or plasma screen or video-projector.

It is noted that the word “register” used in the description of memories 62, 66 and 67 designates in each of the memories mentioned, both a memory zone of low capacity (some binary data) as well as a memory zone of large capacity (enabling a whole program to be stored or all or part of the data representative of data calculated or to be displayed).

When switched-on, the microprocessor 61 loads and executes the instructions of the program contained in the RAM 67.

The random access memory 67 notably comprises:
in a register 670, the operating program of the microprocessor 61 responsible for switching on the device 6,
the source program 671 comprising the rules and rules expressions to be executed at runtime on the graphics card 62;
the first data structure 672 resulting from the compiling of the source program 671;
the second data structure 673 resulting from the compiling of the source program 671;
the third data structure 674 resulting from the compiling of the source program 671;
the fourth data structure 675 resulting from the compiling of the source program 671.

The algorithms implementing the steps of the method specific to the invention and described hereafter are stored in the memory RAM 67 associated with the device 6 implementing these steps. When switched on and once the source program 671 is loaded into the RAM 67, the CPU 61 performs the compiling of the source program and execute instructions of the compiling process. The first, second, third and fourth data structures issued from the compiling process are transmitted to the GRAM 621 via the bus 65, as such or after a further compiling process for the second 673 and third 674 data structures. The first and fourth data structures are advantageously flat libraries and the second and third data structures are algorithms in the form of microprograms of “shader” type using HLSL (High Level Shader Language) language or GLSL (OpenGL Shading Language) for example

The random access memory GRAM 621 notably comprises:
in a register 6210, the first data structure with the identifiers of the rule type, the expressions rules and the successors,
in a register 6211, the second data structure,
in a register 6212, the third data structure,
in a register 6213, the fourth data structure.

At runtime, the GPUs 620 runs the first, second, third and fourth data structures, the second and third data structures being used for interpreting the rules and expressions identified in the first data structures as well as the global parameters comprised in the fourth data structure. The graphic processors 620 execute the instructions of these algorithms in the form of microprograms of “shader” type using HLSL (High Level Shader Language) language or GLSL (OpenGL Shading Language) for example.

According to a variant, the power supply 68 is external to the device 6.

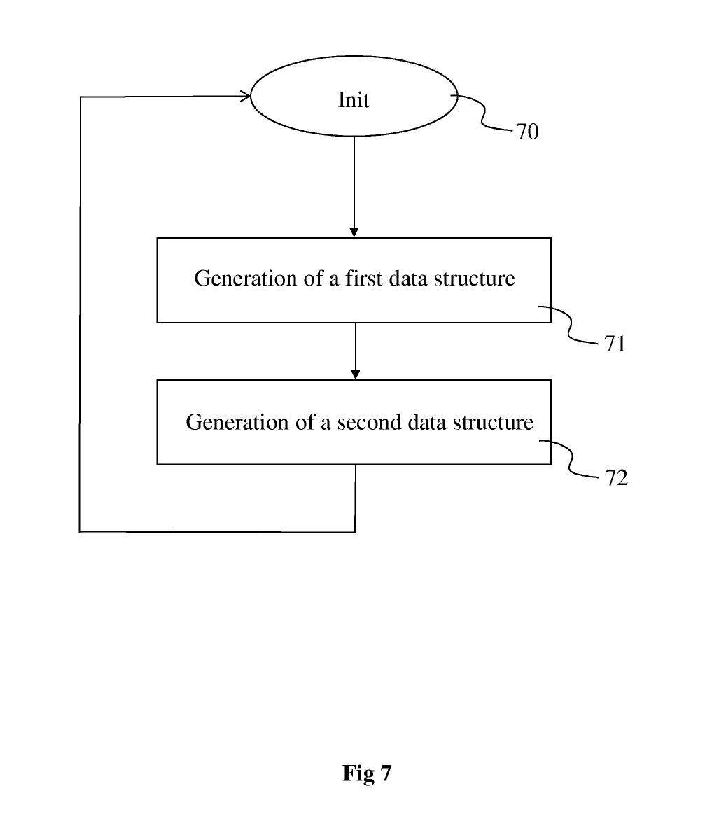

FIG. 7 shows a method for compiling a source program, which comprises at least a first rule not supported by the target runtime environment implemented in the device 6, according to a non-restrictive embodiment of the invention.

During an initialization step 70, the different parameters of the device 6 are updated. In particular, the parameters of the compiler are initialized in any way.

Then, during a step 71, a first data structure is generated. The first data structure advantageously corresponds to a flat representation of the source program, a first identifier being associated with each first rule of the source program for identifying it. The first identifier belongs to a first set of integers and identifies for example the rule type of the rule, the rule type being itself an identifier of the first rule. According to a variant, the first identifier comprised in the first data structure is the rule type identifier itself, which enables to avoid assigning an identifier to the rule type identifier.

The first rule(s) comprises advantageously a plurality of components associated with it(them), for example one or several of the following components:
a predecessor corresponding to the rule preceding the current rule in the directed graph representing the source program;
a rule type for identifying the current rule;
one or several rule expressions corresponding to the parameters associated with the current rule, the rule expressions being for example any fixed value or a parametric expression, the value of which varying at runtime;
one or several successors corresponding to the following rule(s) of the current rule in the directed graph, i.e. the rules to be executed after the current rule at runtime. Internal parameter(s) are associated or not with the successor, according to the type of the successor rule.

Advantageously, the components of the first rule are encoded in the first data structure with a predetermined order, which is for example derivate from the directed graph. The order of the fields associated with each of the components may be different from a first rule to another one, according to the rule type for example. When the first rule comprises several components, for example expression(s) and/or successor(s), an identifier is assigned to each of the data field associated with the components. For example, a second identifier is associated with the field of a successor pointing to the field comprising the identifier of the rule type corresponding to the successor, the identifier of this rule type being a so called first identifier. A local parameter is advantageously associated with the successor rule, the value of the local parameter being able to be modified each time this successor rule is pointed to or called (for example by incrementing or decrementing this parameter value). This enables to implement a stack mechanism which enables to implement recursion without copying n times the rule code in the program to be run on the target environment. Other unique identifiers (called second or third identifier) may also be associated to each of the rule expressions associated with the first rule. All the first, second and third identifiers are advantageously integers as to simplify the reading of the first data structure comprising them at runtime. The first, second and third identifiers advantageously belongs to different series of integers, depending from the type of the value corresponding to the successor or the expressions, example of value types being integer, float and Boolean. Thus, different third identifiers identifying different rule expressions of different type belong to different integer identifiers series and identifiers of rule type, rule expressions or successors may belong to a same series of integer if their values are of the same type (for example integer).

Then, during a step 71, a second data structure is generated. The second data structure comprises instructions or functions used at runtime for interpreting the first rule which is not supported by the target runtime environment. The instructions are coded with a code which is supported by the target runtime environment, for example GLSL or HLSL when the target environment corresponds to a GPU. The instructions of the second data structure comprise for example functions for the reading of the first data structure, functions for the interpreting of the rules (several elementary functions supported by the target runtime environment being for example necessary to interpret the first rule), functions for the interpreting of the expressions associated with the first rule.

According to a variant, the functions supported by the target runtime environment used for interpreting the expressions of the first rule form a third data structure different from the second data structure. When the source program comprises one or several global parameter(s), a fourth data structure comprising them is generated and instructions for reading the fourth data structure and interpreting the global parameters are added to the third data structure. The global parameters are advantageously modified at runtime by a user via an appropriate user interface. It enables to generate or regenerate an object of a virtual environment on the fly with new value(s) for the global parameter(s) without recompiling the first, second, third and fourth data structures as the global parameter(s) is(are) expressed in a parametric way in the interpreter (second and/or third data structures) and not with fixed value(s).

According to another variant, the second and third data structure are compiled to translate the respective first and second instructions that they comprise into a machine language used by the processor of the target environment. According to this variant, the first and fourth structures are not compiled into the machine language as there is no need for. Indeed, the first and fourth data structures are independent from the target environment (for example GLSL) as they only include identifiers and global parameter values and no instructions.

The steps 70 to 72 are advantageously performed in a source environment which is different from the target environment, the source environment comprising for example one or several CPUs and the target environment comprising for example one or several GPUs.

The steps 70 to 71 are reiterated for each new source program to be compiled before execution on the target environment.

Naturally, the invention is not limited to the embodiments previously described.

In particular, the invention is not limited to a method for compiling a source program but also extends to any device implementing this method and notably any devices comprising at least one CPU and at last one GPU.

The invention also relates to a method for composition/rendering of a video image, in two dimensions or in three dimensions, wherein the rules and expressions of the source program are used for rendering the video image(s).

The combination of an interpreter with user-defined grammar expressions could be performed using dynamic libraries on a classical processor, such as a CPU. As current graphics hardware does not allow the use of such libraries, the interpreter code is combined with the grammar-specific expression library. The result is a high performance, expression-instantiated interpreter for the target grammar ready to be executed at any stage of the graphics pipeline (on GPUs).

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for compiling a source program, the source program comprising at least a first rule not supported by a target environment, wherein the method comprises
generating a directed graph representative of the source program,
generating a first data structure, the first data structure corresponding to a flat representation of said directed graph, said first data structure comprising at least a first identifier identifying the at least a first rule,
generating a second data structure comprising first instructions adapted for interpreting the first data structure by using the at least a first identifier, the first instructions being coded into a code supported by the target environment.

2. The method according to claim 1, wherein at least a rule type, at least a successor and at least a rule expression are associated with the at least a first rule.

3. The method according to claim 2, wherein at least one of the at least a rule expression is a parametric expression, the at least a parametric expression comprising at least a global parameter modified at runtime.

4. The method according to claim 2, wherein the at least a first identifier identifies the at least a rule type and wherein at least a second identifier is used in the first data structure for identifying the at least a successor and the at least a rule expression.

5. The method according to claim 4, wherein the at least a second identifier identifying the at least a successor identifies a pointer pointing to a second rule identified in the first data structure.

6. The method according to claim 2, wherein at least a local parameter is associated with the at least a successor, the value of the parameter being modified each time the at least successor with each the parameter is associated is pointed in a first rule.

7. The method according to claim 4, wherein the at least a first identifier and the at least a second identifier belong to at least a series of integer according to the type of the values taken by at least a rule type, the at least a successor and the at least a rule expression, the type of the values belonging to the group comprising:
an integer,
a float,
a Boolean.

8. The method according to claim 2, wherein the method further comprises generating a third data structure comprising second instructions adapted for interpreting the at least a rule expression, said second instructions being coded into a code supported by the target environment.

9. The method according to claim 1, wherein the method further comprises a-step of generating a fourth data structure comprising at least a global parameter comprised in the source program.

10. The method according to claim 1, wherein the method is implemented on a source environment that is different from the target environment.

11. The method according to claim 10, wherein the source environment implements at least a central processing unit and the target environment implements at least a graphics processing unit.

12. The method according to claim 1, wherein it further comprises a step of compiling the second data structure into machine language.

13. A device configured for compiling a source program, the source program comprising a first rule not supported by a target environment, the device comprises at least a processor configured for:
generating a directed graph representative of the source program,
generating a first data structure, the first data structure corresponding to a flat representation of said directed graph, said first data structure comprising at least a first identifier associated with the at least a first rule,
generating at least a second data structure comprising first instructions adapted for interpreting the first data structure by using the at least a first identifier, the first instructions being coded into a code supported by the target environment.

14. The device according to claim 13, wherein the at least a processor is a Central Processing Unit.

15. A computer program product, comprising instructions of program code for executing the steps of the method according to claim 1, when said program is executed on a computer.
